(19) United States
(12) Patent Application Publication
(10) Pub. No.: US 2005/0057717 A1
(43) Pub. Date: Mar. 17, 2005

(54) Substrate assemblys, methods of manufacturing the substrate assembly, display devices having the substrate assembly, and methods of manufacturing display device having the substrate assembly

(76) Inventor: Soo-Guy Rho, Suwon-si (KR)

Correspondence Address: DLA PIPER RUDNICK GRAY CARY USA, LLP, 2000 UNIVERSITY AVENUE, E. PALO ALTO, CA, 94303-2248, US

(21) Appl. No.: 10/942,294

(22) Filed: Sep. 15, 2004

(30) Foreign Application Priority Data
Sep. 15, 2003 (KR) 2003-63773

(51) Int. Cl. G02F 1/1333

(52) U.S. Cl. 349/158

(57) ABSTRACT

A substrate assembly includes a first substrate, a second substrate and a sealing member. The first substrate has a first hardness of a first area. The second substrate has a second hardness lower than the first hardness of the first substrate. The second substrate has a second area smaller than the first area. The second substrate is disposed on the first substrate. The sealing member seals an edge portion of a boundary defined by the first and second substrates so that chemical solutions or chemical gases may not permeate into the boundary, thereby preventing failures of pixels while the pixels are formed on the second substrate.

### CROSS-REFERENCE TO RELATED APPLICATION

This application relies for priority upon Korean Patent Application No. 2003-63773, filed on Sep. 15, 2003, the contents of which are herein incorporated by reference in its entirety.

### BACKGROUND OF THE INVENTION

1. Field of the Invention

The present invention relates to a substrate assembly, a method of manufacturing the substrate assembly, a display device having the substrate assembly, and a method of manufacturing the display device including the substrate assembly.

2. Description of the Related Art

In general, a display device, for example a liquid crystal display (LCD) device, an organic electro luminescence display (OLED) device, a plasma display panel (PDP) device etc., converts an electric signal generated from an information processing device into an image.

The display device has a plurality of pixels for displaying the image. The pixels are formed in a matrix shape on a rigid transparent substrate such as a glass substrate. Hence, a user has difficulty in bending the rigid transparent substrate of the display device.

It is difficult to form the pixels on the bendable substrate of the display device, and the pixels may be broken when the pixels are formed on the bendable substrate using a conventional process.

### SUMMARY OF THE INVENTION

Accordingly, the present invention is provided to substantially settle one or more problems due to limitations and disadvantages of the related art.

The present invention provides a substrate assembly capable of bending and reducing failures of the pixels.

The present invention also provides a method of manufacturing the substrate assembly.

The present invention also provides a display device having the substrate assembly.

The present invention still also provides a method of manufacturing the display device having the substrate assembly.

In some embodiments of the present invention, a substrate assembly includes a first substrate having a first hardness, a second substrate having a second hardness smaller than the first hardness, and a sealing member configured to seal a first edge portion defined by the first substrate and the second substrate. The second substrate is disposed on the first substrate.

In another embodiments of the present invention, there is provided a method of manufacturing a substrate assembly. First, a second substrate having a second hardness is formed. A first substrate having a first hardness is formed on the second substrate. The first hardness is smaller than the second hardness. A sealing member is formed to seal a first edge portion defined by the first substrate and the second substrate. In further another embodiments of the present invention, a substrate assembly includes a first substrate having a first hardness, a second substrate facing the first substrate, an adhesive member to couple the first substrate to the second substrate, and a sealing member configured to seal an edge portion defined by the first substrate and the second substrate. The second substrate has a second hardness lower than the first hardness of the first substrate. In still further another embodiments of the present invention, a display device for displaying an image includes a first substrate including a first flexible material, a second substrate, a first electrode, a second electrode, and a liquid crystal layer. The second substrate includes a second flexible material, and the second substrate faces the first substrate. The first electrode is disposed on the first substrate. The second electrode is disposed on the second substrate. The liquid crystal layer is interposed between the first electrode and the second electrode. In accordance with still another aspect of the present invention, there is provided a method of manufacturing a display device. In the method, a first display substrate is formed by disposing a second substrate having a second hardness on a first substrate that has a first hardness larger than the second hardness of the second substrate, by sealing an edge portion of a boundary defined by the first substrate and the second substrate, and by forming a first pixel on the second substrate so as to display an image. A second display substrate is formed by disposing a fourth substrate having a fourth hardness on a third substrate that has a third hardness larger than the fourth hardness of the fourth substrate, by sealing an edge portion of a boundary defined by the third substrate and the fourth substrate, and by forming a second pixel on the fourth substrate so as to display the image. The first display substrate and the second display substrate are assembled in which the first pixel is opposed to the second pixel. Then, the first substrate is separated from the second substrate, and the third substrate is separated from the fourth substrate.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a schematic plan view illustrating a substrate assembly in accordance with one exemplary embodiment of the present invention;

FIG. 2A is a cross-sectional view taken along a line A₁-A₂ of FIG. 1;

FIG. 2B is a cross-sectional view illustrating a substrate assembly in accordance with another exemplary embodiment of the present invention;

FIG. 3 is a schematic plan view illustrating a substrate assembly in accordance with still another exemplary embodiment of the present invention;

FIG. 4 is a cross-sectional view taken along a line B₁-B₂ of FIG. 3;

FIG. 5 is a cross-sectional view illustrating a substrate assembly in accordance with still another exemplary embodiment of the present invention;

FIGS. 6A through 6E are cross-sectional views illustrating a method of manufacturing a substrate assembly in accordance with one exemplary embodiment of the present invention;

FIG. 7 is a cross-sectional view illustrating a display device in accordance with one exemplary embodiment of the present invention; and

FIGS. 8A through 8I are cross-sectional views and schematic plan views illustrating a method of manufacturing a display device with one exemplary embodiment of the present invention.

### DETAILED DESCRIPTION OF INVENTION

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, the thickness of layers and regions are exaggerated for clarity. Like numbers refer to similar or identical elements throughout. It will be understood that when an element such as a layer, region or substrate is referred to as being “on” or “onto” another element, it can be directly on the other element or intervening elements may also be present.

Substrate Assembly

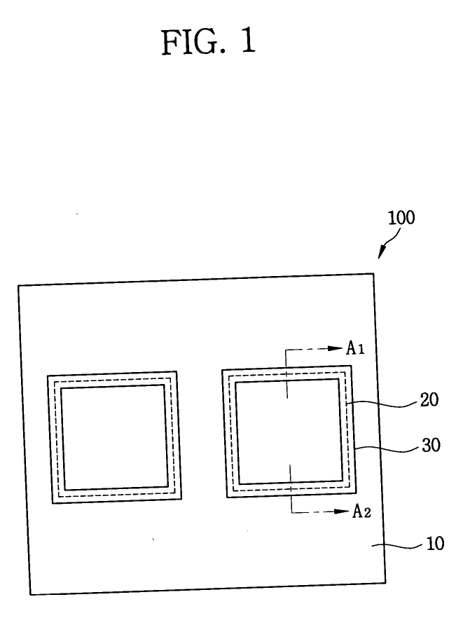

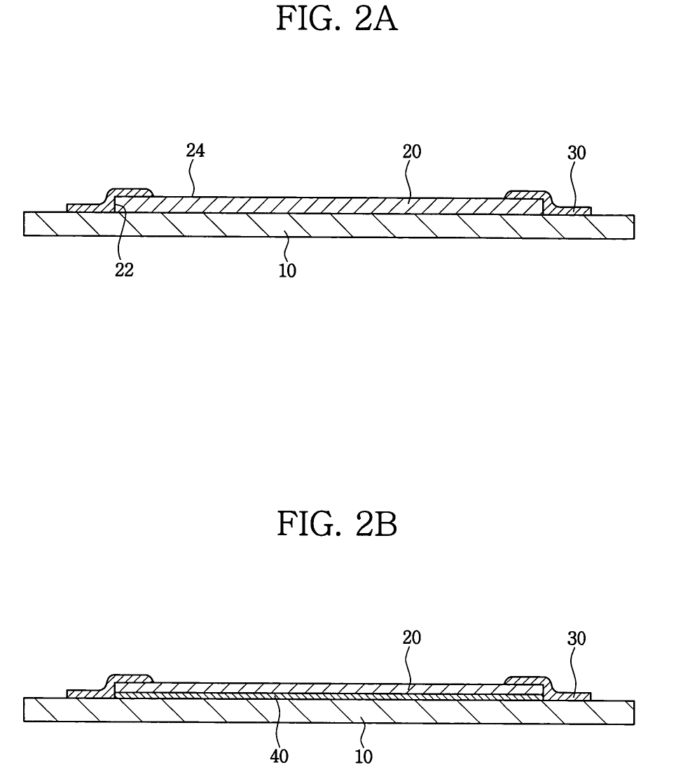

FIG. 1 is a schematic plan view illustrating a substrate assembly in accordance with one embodiment of the present invention. FIG. 2A is a cross-sectional view taken along a line A₁-A₂ of FIG. 1.

Referring to FIGS. 1 and 2A, a substrate assembly 100 includes a first substrate 10, a second substrate 20 and a sealing member 30.

The first substrate 10 has a first hardness. The first hardness of the first substrate 10 may be measured using a Brinell hardness testing method, a Rockwell hardness testing method, a Vickers hardness testing method, or a Shore hardness testing method.

For example, the first substrate 10 includes a transparent glass or opaque metal, etc. The first substrate 10 includes a plate shape having a first area. The first substrate 10 supports the second substrate 20.

The second substrate 20 has a second hardness. The second hardness of the second substrate 20 is smaller than the first hardness of the first substrate 10. The second hardness of the second substrate 20 may be measured using the Brinell hardness testing method, the Rockwell hardness testing method, the Vickers hardness testing method, and the Shore hardness testing method, etc.

For example, the second substrate 20 may include a synthetic resin such as polycarbonate (PC), polyimide (PI), polyethersulphone (PES), polyacrylate (PAR), polyethylenenaphthelate (PEN), or polyethyleneterephehalate (PET).

The second substrate 20 has a plate shape of a second area smaller than the first area of the first substrate 10.

The second substrate 20 is disposed on the first substrate 10. The first and second substrates 10 and 20 have different thermal expansion coefficients because the first and second substrates 10 and 20 have different materials from each other. Thus, the first substrate 10 and the second substrate 20 disposed on the first substrate 10 may be bent due to a difference between the thermal expansion coefficients when heat is applied to the first and second substrates 10 and 20.

In order to reduce the bending of the substrates 10 and 20, the first substrate 10 and the second substrate 20 have a different thickness from each other. Alternatively, the first substrate 10 and the second substrate 20 may have a different area from each other.

For example, the surface area of the second substrate 20 is smaller than the surface area of the first substrate 10 so that the degree to which the first and second substrates 10 and 20 are bent may be reduced.

The sealing member 30 seals the second substrate 20 disposed on the first substrate 10. In particular, the sealing member 30 is formed on the first substrate 10 to enclose a lateral portions and edge portions of the second substrate 20.

FIG. 2B is a cross-sectional view illustrating the substrate assembly of FIG. 2A.

Referring to FIG. 2B, an adhesive member 40 is interposed between the first substrate 10 and the second substrate 20. The adhesive member 40 detachably attaches the first substrate 10 to the second substrate 20. For example, the adhesive member 40 may include an adhesive and a both-side adhesive tape, etc.

However, a plurality of pixels for displaying an image is formed on the second substrate 20 by a thin film forming process. The first and second substrates 10 and 20 are exposed to various chemical solutions or various chemical gases while forming the pixels on the second substrate 20. Thus, various chemical solutions or various chemical gases may easily permeate into a boundary between the first and second substrates 10 and 20 so that the first substrate 10 may be easily separated from the second substrate 20.

The sealing member 30 prevents the chemical solutions or chemical gases from permeating into the boundary between the first substrate 10 and the second substrate 20. For example, the sealing member 30 may seal an edge portion of the boundary between the first and second substrates 10 and 20. The sealing member 30 covers a lateral portion 22 and an edge portion of the second substrate 20.

Referring back to FIG. 2A, the sealing member 30 includes a photosensitive material such as a negative type photoresist that reacts with a light. The sealing member 30 is disposed at the boundary between the first and second substrates 10 and 20 so that the sealing member 30 prevents the chemical solutions or chemical gases from permeating into the boundary of the first and second substrates 10 and 20. In order to reduce a stress generated between the sealing member 30 and the second substrate 20, the sealing member 30 advantageously has a band shape.

The photosensitive material included in the sealing member 30 is heat-treated so that the sealing member 30 is hardened. Temperature for the heat-treatment of the sealing member 30 is lower than the melting temperature of the second substrate 20. For example, the sealing member 30 is heat-treated at a temperature between about 100° C. and about 220° C. In addition, the sealing member 30 prevents the second substrate 20 from being damaged or corroded due to the chemical solutions or gases. The sealing member 30 has a thickness in a range from about 2 to about 6 micrometers (μm).

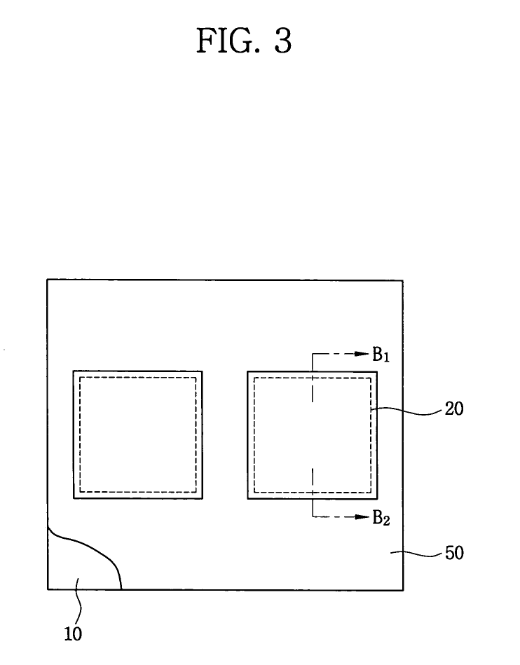

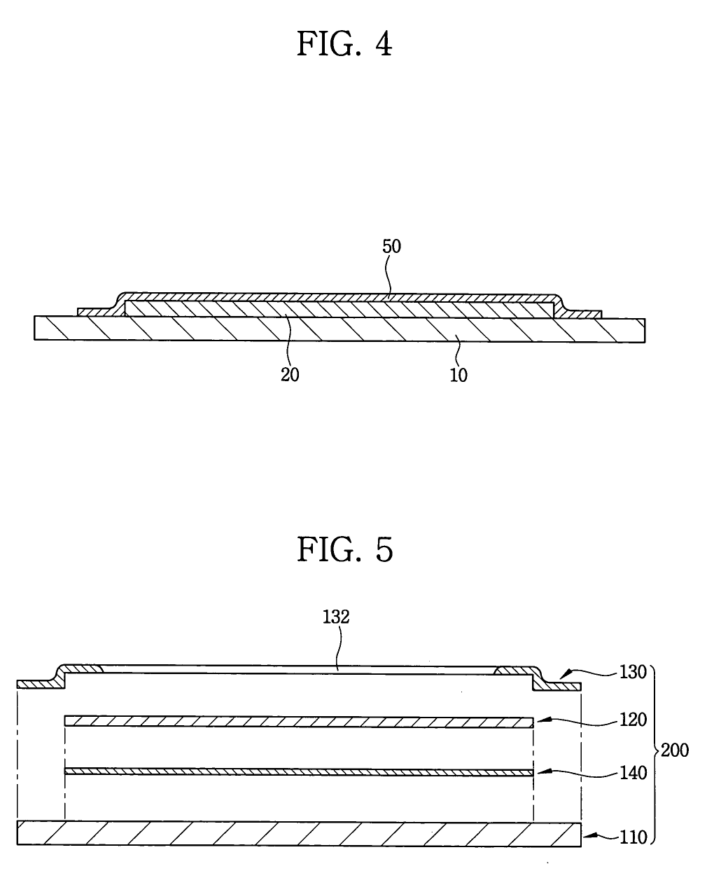

FIG. 3 is a schematic plan view illustrating a substrate assembly in accordance with another exemplary embodiment of the present invention. FIG. 4 is a cross-sectional view taken along a line B₁-B₂ of FIG. 3.

Referring to FIGS. 3 and 4, a sealing member 50 is disposed on a first substrate 10 and a second substrate 20. Here, the sealing member 50 is formed on a portion of the first substrate 10 and on an entire surface of the second substrate 20. That is, the sealing member 50 covers an entire surface of the second substrate 20. The sealing member 50 seals a boundary between the first substrate 10 and the second substrate 20. Additionally, the sealing member 50 improves the flatness of the second substrate 20, thereby preventing failures of the pixels during the process of forming the pixels.

FIG. 5 is an exploded cross-sectional view illustrating a substrate assembly in accordance with still another exemplary embodiment of the present invention.

Referring to FIG. 5, a substrate assembly 200 includes a first substrate 110, a second substrate 120, a sealing member 130 and an adhesive 140.

The first substrate 110 has a first hardness and a first area. In this embodiment, the first substrate 110 has a rectangular plate shape.

The second substrate 120 is disposed on the first substrate 110, and the adhesive 140 is interposed between the first substrate 110 and the second substrate 120. The second substrate 120 has a second hardness lower than the first hardness of the first substrate 110. The second substrate 120 has a second area smaller than the first area of the first substrate 110. In this embodiment, the second substrate 120 also has a rectangular plate shape.

The second substrate 120 includes a flexible synthetic resin so that the second substrate 120 may be easily bent by a user. Although the first and second substrates 110 and 120 may be combined with each other without an adhesive, the first and second substrates 110 and 120 are detachably combined with each other using the adhesive 140 interposed therebetween.

The sealing member 130 has a square frame shape where an opening 132 is formed therethrough. The sealing member 130 is disposed on the first substrate 110 to cover an edge portion of the second substrate 120. The sealing member 130 seals a boundary between the first and second substrates 110 and 120. Thus, various chemical solutions or various chemical gases may not penetrate through the boundary so that the first substrate 110 is not separated from the second substrate 120.

The sealing member 130 may be detachable from or attachable to the first substrate 110. That is, the sealing member 130 may be recycled, thereby reducing the time for sealing the boundary between the first and second substrates 110 and 120.

Alternatively, the sealing member 130 includes a flowable sealing material that seals the boundary between the first and second substrates 110 and 120. Here, the sealing material may include a photosensitive material that reacts with a light. After the sealing material is deposited on the first and second substrates 110 and 120, the sealing material is patterned to form the sealing member 130 on the first and second substrates 110 and 120.

Method of Manufacturing a Substrate Assembly

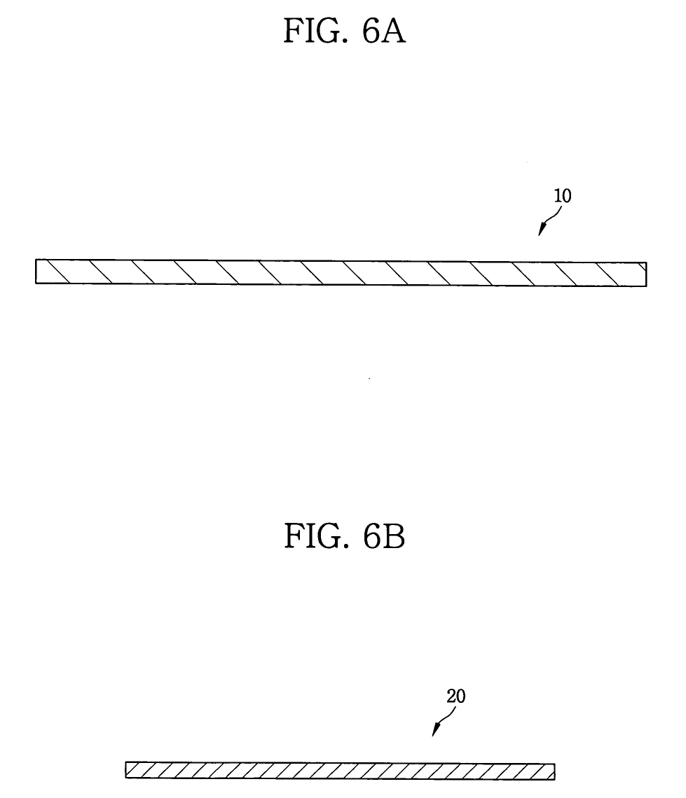

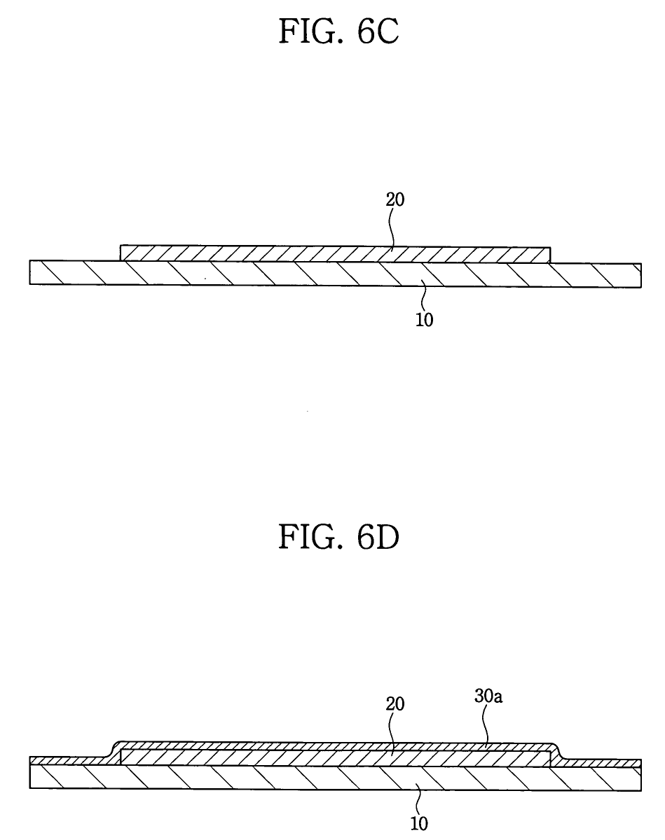

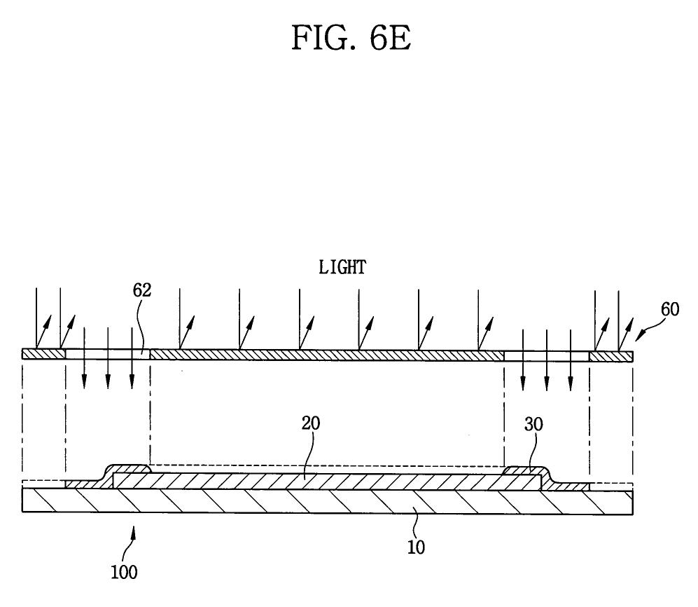

FIG. 6A is a cross-sectional view illustrating a first substrate of a substrate assembly in accordance with still another exemplary embodiment of the present invention. FIG. 6B is a cross-sectional view illustrating a second substrate of the substrate assembly in accordance with still another exemplary embodiment of the present invention.

Referring to FIGS. 6A and 6B, a first substrate 10 and a second substrate 20 are prepared to fabricate a substrate assembly.

The first substrate 10 has a plate shape and a first area. The first substrate 10 has a first hardness sufficient to prevent the first substrate from bending.

However, the second substrate 20 has a plate shape and a second area smaller than the first area. The second substrate 20 has a second hardness smaller than the first hardness of the first substrate 10. The second substrate 20 having the second hardness may be easily bended.

FIG. 6C is a cross-sectional view illustrating the first and second substrates of the substrate assembly in accordance with still another exemplary embodiment of the present invention.

Referring to FIG. 6C, the first substrate 10 is disposed to be opposite to the second substrate 20. The first and second substrates 10 and 20 are assembled using an adhesive material. The adhesive material is interposed between the first and second substrates 10 and 20. The adhesive material may include adhesives or both-side adhesive tape.

FIG. 6D is a cross-sectional view illustrating a sealing material formed on the first and second substrates in accordance with still another exemplary embodiment of the present invention.

Referring to FIG. 6D, a sealing film 30a is formed on the first and second substrates 10 and 20 by a spin coating process or a chemical vapor deposition (CVD) process. In this embodiment, the sealing film 30a is comprised of a flowable negative type photoresist material. Here, the sealing film 30a has a thickness of about 2 to about 6 μm. The sealing film 30a prevents various chemical solutions or chemical gases from permeating into a space between the first and second substrates 10 and 20.

The sealing film 30a is heat-treated at a temperature between about 100° C. and about 220° C.

FIG. 6E is a schematic cross-sectional view illustrating a sealing member formed on the first and second substrates in accordance with one embodiment of the present invention.

Referring to FIG. 6E, the sealing film 30a is partially removed from the first and second substrates 10 and 20 to form the sealing member 30 on the first and second substrates 10 and 20. In order to partially remove the sealing film 30a, a mask 60 is deposed over the second substrate 20. The mask 60 has a light transmitting region 62 which a light passes therethrough and reaches the sealing film 30a positioned on an edge portion of the second substrate 20. Namely, the light passing the mask 60 exposes the sealing film 30a formed on the edge portion of the second substrate 20. Because the sealing film 30a includes the negative type photoresist material, the exposed position of the sealing film 30a remains on the first and second substrates 10 and 20, whereas other portion of the sealing film 30a, which is not exposed to the light, is removed from the first and second substrates 10 and 20. Thus, the sealing member 30 is formed on the first and second substrates 10 and 20 to cover the edge portion of the second substrate 20.

Display Device

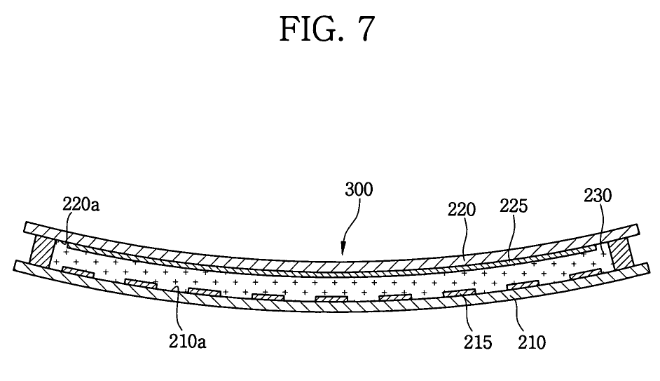

FIG. 7 is a cross-sectional view illustrating a display device in accordance with one exemplary embodiment of the present invention.

Referring to FIG. 7, a display device 300 includes a first substrate 210, a second substrate 220, a first electrode 215, a second electrode 225, and a liquid crystal layer 230.

The first substrate 210 facing the second substrate 220 has a plate shape and is comprised of transparent material. For example, the first substrate 210 is comprised of a transparent flexible material so that the first substrate 210 is bendable. For example, the first substrate 210 is comprised of flexible synthetic resin.

The second substrate 220 also has a plate shape and is comprised of transparent material. For example, the second substrate 220 is comprised of a transparent flexible material so that the second substrate 220 is also bendable. For example, the second substrate 220 is comprised of flexible synthetic resin.

The first electrode 215 is formed on a first face 210a of the first substrate 210. The first electrode 215 is comprised of a transparent conductive material such as indium tin oxide (ITO) or indium zinc oxide (IZO). A plurality of the first electrodes 215 may be disposed on the first face 210a of the first substrate 210 to be arranged in a matrix shape. A thin film transistor (TFT) electrically connected to the first electrode 215 provides a driving voltage to the first electrode 215. In addition, the first substrate 210 includes a first alignment film (not shown) on the first electrode 215. Here, the first alignment film is comprised of a polyimide containing material.

The second electrode 225 is formed on a second face 220a of the second substrate 220 corresponding to the first face 210a of the first substrate 210. The second electrode 225 is comprised of a transparent conductive material such as indium tin oxide (ITO) or indium zinc oxide (IZO). The second electrode 225 is formed on an entire second face 220a of the second face 220a.

Color filter (not shown) may be interposed between the second face 220a of the second substrate 220 and the second electrode 225. The color filter is arranged so that the first electrode 215 corresponds to the respective color filter. In addition, the second substrate 220 includes a second alignment film (not shown) on the second electrode 225. The second alignment film is comprised of polyimide composition material.

The liquid crystal layer 230 is interposed between the first and second electrodes 210 and 220. The liquid crystal layer 230 may include various kinds of liquid crystals operating in a twist nematic (TN) mode and a vertical alignment (VA) mode, etc.

When the liquid crystal layer 230 operates in the TN liquid crystal mode, the first alignment film has a first alignment groove aligned in a first direction and the second alignment film has a second alignment groove aligned in a second direction.

Furthermore, when the liquid crystal layer 230 has the VA mode, the first and second electrodes 210 and 220 have grooves for expanding the viewing angle of the image. The first and second alignment films also have a plurality of protrusions for expanding the viewing angle of the image.

Method of Manufacturing a Display Device

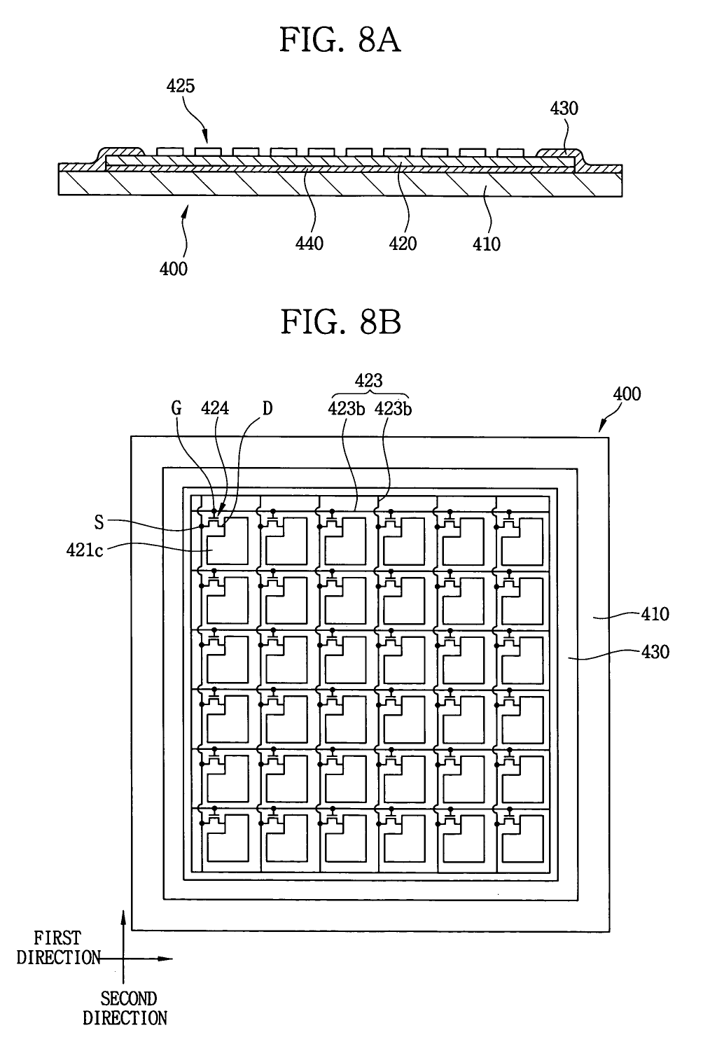

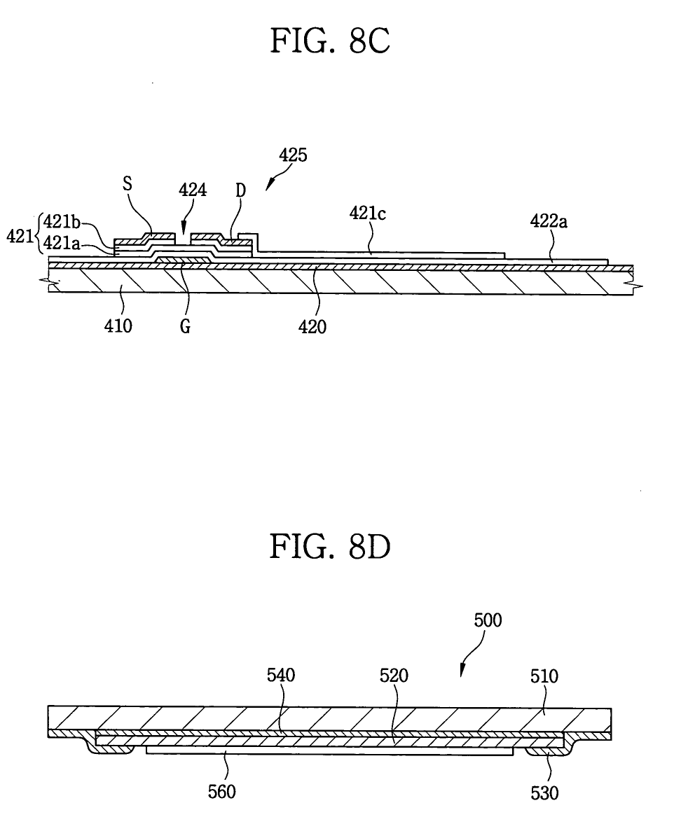

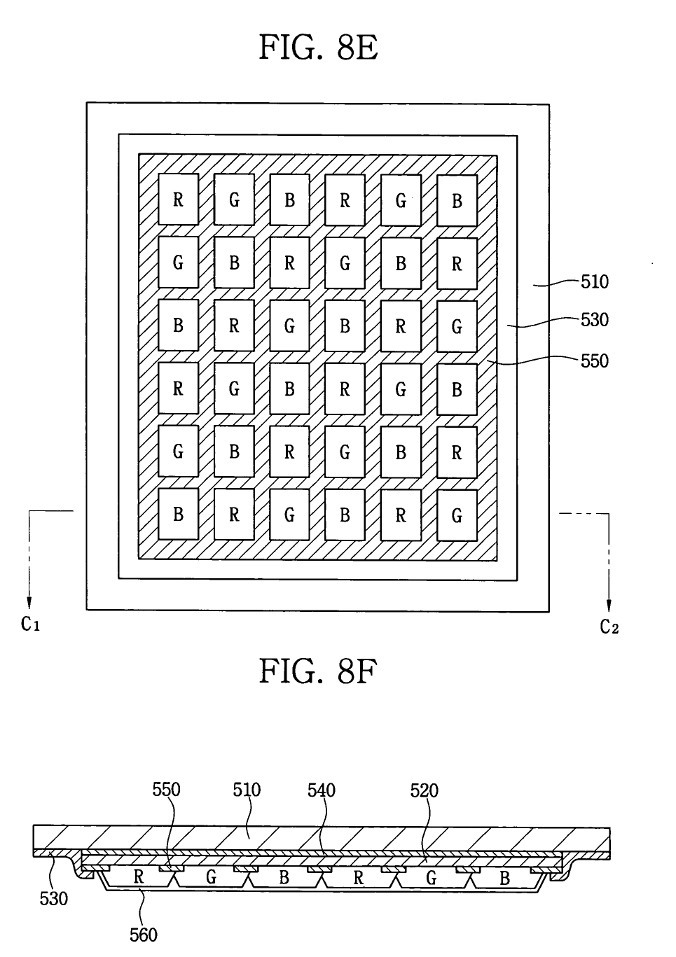

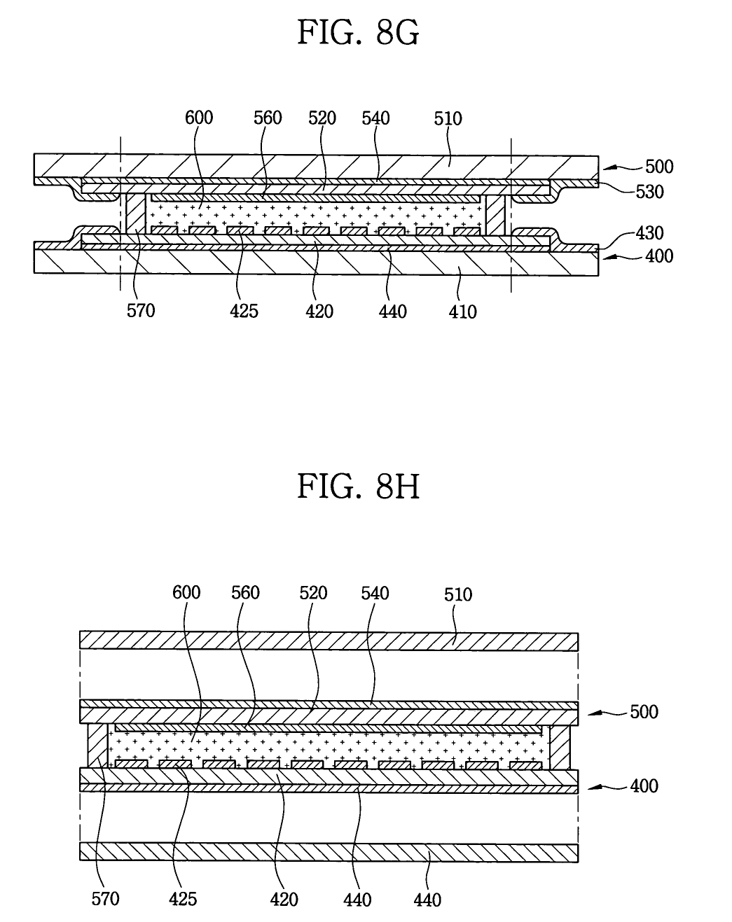

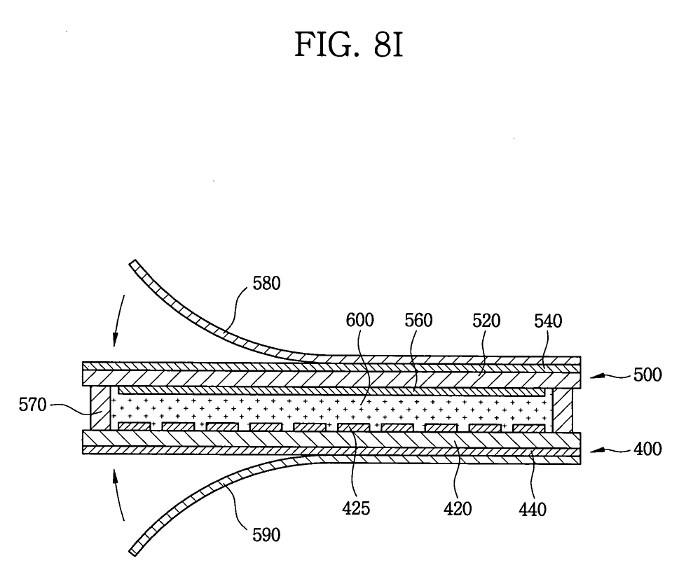

FIG. 8A is a cross-sectional view illustrating a first display substrate of a display device in accordance with one exemplary embodiment of the present invention.

Referring to FIG. 8A, a first display substrate 400 of the display device is provided.

In order to manufacture the first display substrate 400, a second substrate 420 having a plate shape and a second hardness is disposed on a first substrate 410 having a plate shape and a first hardness. The first hardness of the first substrate 410 is higher than the second hardness of the second substrate 420. The second substrate 420 having the second hardness is manufactured using flexible synthetic resin that is bendable. An adhesive member 440 such as an adhesive or a both-side adhesive type attaches the second substrate 420 to the first substrate 410.

After the second substrate 420 is combined with the first substrate 410, an edge portion of a boundary between the first and second substrates 410 and 420 is sealed using a sealing member 430.

FIG. 8B is a schematic plan view illustrating a first pixel formed on the second substrate of FIG. 8A. FIG. 8C is a cross-sectional view illustrating the first pixel in FIG. 8B.

Referring to FIGS. 8B and 8C, a first pixel 425 is formed on the second substrate 420. A thin film transistor (TFT) 424 and a signal line 423 are formed on the second substrate 420 to form the first pixel 425. The signal line 423 and the TFT 424 are simultaneously formed. The signal line 423 includes a gate line 423a and a data line 423b.

In order to form the TFT 424 on the second substrate 420, a gate conductive layer (not shown) is formed on the second substrate 420 by a sputtering process or a chemical vapor deposition (CVD) process. The gate conductive layer includes aluminum (Al) or aluminum alloy. After a photoresist layer is formed on the gate conductive layer by a spin coating process or a slit coating process, the photoresist layer is exposed and developed so as to form a photoresist pattern on the gate conductive layer.

Subsequently, the gate conductive layer is etched by a plasma-etching process or a wet etching process using the photoresist pattern as an etching mask so that the gate line 423a and a gate electrode G are formed on the second substrate 420. The gate electrode G is extended on the second substrate 420 along a first direction. The gate electrode G is electrically connected to the gate line 423a.

For example, when the display device displays a full-color image and has a resolution of about 1024×768, about 768 gate lines 423a are disposed on the second substrate 420 in the first direction. In addition, about 1024×3 gate electrodes G are extended from the gate lines 423a in a second direction substantially perpendicular to the first direction. That is, the gate lines 423a are substantially perpendicular to the gate electrodes G, respectively.

A gate insulation layer 422a is formed on an entire surface of the second substrate 420. The gate insulation layer 422a covers the gate lines 423a and the gate electrodes G.

A channel layer (not shown) and a source/drain conductive layer (not shown) are formed on the gate insulating layer 422a. The source/drain conductive layer is patterned by a photolithography process so that the data lines 423b, a source electrode S and a drain electrode D are formed on the gate insulating layer 422a.

The data lines 423b are formed on the gate insulation layer in the second direction. Thus, the data lines 423b are substantially perpendicular to the gate lines 423a, respectively.

For example, when the display device of the full-color image has the resolution of about 1024×768, approximately 1024 data lines 423b are disposed on the second substrate 420 in the second direction. Additionally, approximately 768 source electrodes S are extended from the data lines 423b in a first direction, respectively. Here, the data lines 423b are substantially perpendicular to the source electrodes S, respectively. One source electrode S is apart from another source electrode S by a predetermined interval. The drain electrode D having an island shape is positioned adjacent to the source electrode S.

The channel layer is etched using the data line 423b, the source electrode S and the drain electrode D as etching masks to form a channel pattern 421 on the gate insulating layer 422a.

The channel pattern 421 includes an amorphous silicon channel pattern 421a and an n⁺ silicon channel patterns 421b. The n⁺ silicon patterns 421b are disposed on the amorphous silicon pattern 421a by a predetermined distance. The n⁺ silicon patterns 421b are disposed beneath the source electrode S and the drain electrode D, respectively.

A conductive transparent layer (not shown) including indium tin oxide (ITO) or indium zinc oxide (IZO) is formed on the entire surface of the second substrate 420. The conductive transparent layer is etched so that a first electrode 421c is formed on the gate insulating layer 422a. The first electrode 421c is electrically connected to the drain electrode D.

After the first electrode 421c is formed on the second substrate 420, a first alignment film (not shown) is disposed on the entire surface of the second substrates 420 to cover the first electrode 421c.

FIG. 8D is a cross-sectional view illustrating a second display substrate of the display device in accordance with one exemplary embodiment of the present invention.

Referring to FIG. 8D, a second display substrate 500 of the display device is prepared.

In order to form the second display substrate 500, a fourth substrate 520 having a plate shape and a fourth hardness is disposed on a third substrate 510 having a plate shape and a third hardness. The third hardness of the third substrate 510 is higher than the fourth hardness of the fourth substrate 520. The fourth substrate 520 having the fourth hardness is formed using flexible synthetic resin that is bendable. An adhesive member 540 such as an adhesive or a both-side adhesive type attaches the third substrate 510 to the fourth substrate 520.

After the third and fourth substrates 510 and 520 are combined with each other, an edge portion of a boundary between the third and fourth substrates 510 and 520 is sealed using a sealing member 530.

FIG. 8E is a plan view illustrating the second display substrate of FIG. 8D. FIG. 8F is a cross-sectional view taken along a line C₁-C₂ of FIG. 8D.

Referring to FIGS. 8E and 8F, a metal film including chromium (Cr) or chromium oxide (CrxOy) is disposed on the fourth substrate 520. The metal film is etched by a photolithography process and has a lattice structure so that a black matrix 550 having openings (not shown) is formed on the fourth substrate 520.

A red color filter R for transmitting a red light therethrough, a green color filter G for transmitting a green light therethrough, and a blue color filter B for transmitting a blue light therethrough are formed in the openings of the black matrix 550 in a matrix shape.

A second electrode 560 is formed on the fourth substrate 520 including the red, green and blue color filters. The second electrode 560 includes a conductive transparent material, for example, ITO or IZO.

After the second electrode 560 is formed on the fourth substrate 520, a second alignment film (not shown) is disposed on an entire surface of the fourth substrate 520 to cover the second electrode 560.

FIG. 8G is a cross-sectional view illustrating the display device including the first and second display substrates.

Referring to FIG. 8G, a sealant 570 is interposed between the first and second display substrates 400 and 500. Here, the sealant 570 is formed on the first display substrate 400 or on the second display substrate 500. For example, the sealant 570 of a close loop shape is formed on the first display substrate 400.

The sealant 570 functions as an adhesive for combining the first and second display substrates 400 and 500, and the sealant 570 also serves as a sealing member for sealing a liquid crystal layer 450 positioned between the first display substrate 400 and the second display substrate 500.

FIG. 8H is a cross-sectional view illustrating the display device including the first and second display substrates without the first and third substrates.

Referring to FIG. 8H, the first substrate 410 of the first display substrate 400 is removed from the second substrate 420. The third substrate 510 of the second display substrate 500 is also removed from the fourth substrate 520. The adhesive members 440 and 540 may remain on or removed from the second and fourth substrates 420 and 520.

FIG. 8I is a cross-sectional view illustrating the display device including polarizing plates disposed on the first and second display substrates, respectively.

Referring to FIG. 8I, after the first substrate 410 is separated from the first display substrate 400, a first polarizing plate 580 is attached to the second substrate 420. In addition, after the third substrate 510 is separated from the second display substrate 400, a second polarizing plate 580 is also attached to the fourth substrate 520 to thereby completing the display device.

According to the present invention, the second substrate that has the second hardness smaller than the first hardness is disposed on the first substrate having the first hardness. The boundary between the first and second substrates and is sealed using the sealing member. Thus, various chemical solutions or chemical gases do not permeate into the space formed between the first and second substrate so that the second substrate is not separated from the first substrate.

According to the present invention, the substrates of the display device may be bendable, and the pixels are formed on the flexible substrates so that the display device displays the image even when the display device is bent.

According to the present invention, a substrate assembly includes a flexible substrate and a hard substrate. The flexible substrate is disposed on the hard substrate. An edge portion of a boundary between the flexible substrate and the hard substrate is sealed using a sealing member so that chemical solutions or chemical gases may not permeate into the boundary of the flexible and the hard substrate. Thus, the flexible substrate and the hard substrate may not be separated from each other while pixels are formed on the flexible substrate to display an image.

Having described the exemplary embodiments of the present invention and its advantages, it is noted that various changes, substitutions and alterations can be made herein without departing from the spirit and scope of the invention as defined by appended claims.

1. A substrate assembly comprising:
a first substrate having a first hardness;
a second substrate having a second hardness smaller than the first hardness, the second substrate being disposed on the first substrate; and
a sealing member configured to seal a first edge portion defined by the first substrate and the second substrate.

2. The substrate assembly of the claim 1, wherein the first substrate includes a glass material or a metal material.

3. The substrate assembly of the claim 1, wherein the sealing member is comprised of a photosensitive material.

4. The substrate assembly of the claim 3, wherein the photosensitive material is heat-treated at a temperature between about 100° C. and about 220° C., and wherein the photosensitive material is comprised of a negative type photoresist.

5. The substrate assembly of the claim 3, wherein the sealing member has a thickness in a range from about 2 micrometers (μm) to about 6 micrometers (μm).

6. The substrate assembly of the claim 1, further comprising an adhesive member interposed between the first substrate and the second substrate.

7. The substrate assembly of the claim 1, wherein the first substrate has a first area larger than a second area of the second substrate.

8. The substrate assembly of the claim 1, wherein the sealing member encloses a second edge of the second substrate and partially encloses a top face of the second substrate.

9. The substrate assembly of the claim 1, wherein the sealing member covers the first substrate and the second substrate.

10. A method of manufacturing a substrate assembly, comprising:
forming a second substrate having a second hardness;
forming a first substrate having a first hardness on the second substrate, the first hardness being smaller than the second hardness; and
forming a sealing member to seal a first edge portion defined by the first substrate and the second substrate.

11. The method of claim 10, further comprising forming an adhesive member between the first substrate and the second substrate.

12. The method of claim 10, wherein said forming a sealing member comprises coating a photosensitive material on the first and second substrates to form a photosensitive layer, patterning the photosensitive layer to form the sealing member, and heat-treating the sealing member.

13. The method of claim 12, wherein the sealing member covers a second edge portion of the second substrate.

14. The method of claim 12, wherein the sealing member is heat-treated at a temperature between about 100° C. and about 220° C.

15. A substrate assembly comprising:
a first substrate having a first hardness;
a second substrate facing the first substrate, the second substrate having a second hardness lower than the first hardness of the first substrate;
an adhesive member to couple the first substrate to the second substrate; and
a sealing member configured to seal an edge portion defined by the first substrate and the second substrate.

16. The substrate assembly of the claim 15, wherein the first substrate includes a glass material, and the second substrate includes a flexible material.

17. A display device for displaying an image, the display device comprising:
a first substrate including a first flexible material;
a second substrate including a second flexible material, the second substrate facing the first substrate;
a first electrode disposed on the first substrate;
a second electrode disposed on the second substrate; and
a liquid crystal layer interposed between the first electrode and the second electrode.

18. A method of manufacturing a display device comprising:
forming a first display substrate by disposing a second substrate having a second hardness on a first substrate having a first hardness larger than the second hardness, by sealing an edge portion defined between the first substrate and the second substrate, and by forming a first pixel on the second substrate so as to display an image;
forming a second display substrate by disposing a fourth substrate having a fourth hardness on a third substrate having a third hardness larger than the fourth hardness of the fourth substrate, sealing an edge portion defined by the third substrate and the fourth substrate, and forming a second pixel on the fourth substrate to display the image;
assembling the first display substrate and the second display substrate wherein the first pixel is opposed to the second pixel; and
separating the first substrate from the second substrate, and separating the third substrate from the fourth substrate.

19. The method of the claim 18, wherein the second substrate and the fourth substrate include polarizing plates.

20. The method of the claim 18, further comprising forming a liquid crystal layer between the first display substrate and the second display substrate.
